(19) United States
(12) Patent Application Publication
(10) Pub. No.: US 2018/0059982 A1
(43) Pub. Date: Mar. 1, 2018

(54) Data Storage Systems and Methods Thereof to Access Raid Volumes in Pre-Boot Environments

(71) Applicant: Samsung Electronics Co., Ltd., Suwon-si (KR)

(72) Inventors: Suman Prakash Balakrishnan, Bangalore (IN); Amit Kumar, Bangalore (IN); Arka Sharma, Bangalore (IN)

(21) Appl. No.: 15/641,727

(22) Filed: Jul. 5, 2017

(30) Foreign Application Priority Data
Aug. 25, 2016 (IN) 201641028979

(51) Int. Cl. G06F 3/06; G06F 13/42

(52) U.S. Cl. CPC G06F 3/0632; G06F 13/4282; G06F 3/0689; G06F 3/0604

(57) ABSTRACT

A data storage system and method thereof to access a raid volume in pre-boot environment are provided. The data storage system may include a processor, a memory coupled to the processor, a host controller interface coupled to the processor, and a plurality of storage devices coupled to the host controller interface, the plurality of storage devices including a respective plurality of Option Read Only Memories (ROMs). The processor may be configured to execute a system code loaded from one of the plurality of Option ROMs to cause the processor perform operations comprising forming a Redundant Array of Independent Disks (RAID) volume from at least two of the plurality of storage devices.

### CROSS-REFERENCE TO RELATED APPLICATION

This U.S. non-provisional patent application claims priority under 35 U.S.C. § 119 to Indian Patent Application No. 201641028979 filed on Aug. 25, 2016, in the Indian Intellectual Property Office, the entire content of which is herein incorporated by reference.

### BACKGROUND

Embodiments of the inventive concepts herein generally relate to storage devices. More particularly, embodiments of the inventive concepts relate to data storage systems and methods thereof to access Redundant Array of Independent Disks (RAID) volumes in a pre-boot environment.

RAID technology in data processing systems refers to a Redundant Array of Independent Disks, a system of multiple hard disk drives that share or replicate data among the drives. Multiple versions of the RAID technology have been developed to enable increased data integrity, fault-tolerance, throughput, and/or capacity in comparison to single drives. RAID enables combinations of multiple readily available and low-cost devices into an array with larger capacity, reliability, and/or speed.

The various versions or levels of the RAID technology include RAID level ‘0’ with data striping that breaks data into smaller chunks and distributes the chunks among multiple drives to enhance throughput, but does not duplicate the data. RAID level ‘1’ enables mirroring, which is copying of the data onto at least one other drive, ensuring duplication so that the data lost in a disk failure can be restored. The RAID levels ‘0’ and ‘1’ can be combined to facilitate both throughput and data protection. RAID level ‘5’ stripes both data and parity information across three or more drives and is also fault tolerant.

Further, RAID technology can be implemented either in hardware or software. Software RAID often supports RAID levels ‘0’ and ‘1’ so that RAID functions are executed by a host Central Processing Unit (CPU), possibly causing a reduction in performance of other computations. An additional reduction in performance may also bee seen during performance of the RAID level ‘5’ writes since parity is calculated. Hardware RAID implementations offload processor intensive RAID operations from the host CPU to enhance performance and fault-tolerance and are generally richer in features.

RAID may also be provided in a pre-boot environment. Some conventional methods provide either a hardware RAID controller or an emulated RAID card, which may emulate the hardware RAID controller using software. With the hardware RAID controller and/or the emulated RAID card, RAID volumes may need to be created with physical disks connected to ports exposed by the hardware RAID controller or the emulated RAID card. With the advent of Peripheral Component Interconnect Express (PCIe) based solid-state drives (SSDs) such as Serial ATA Express (SATAe) or Non-Volatile Memory Express (NVMe), the conventional systems and methods may not be suitable. As in ease of the PCIe based SSDs, there may only be one controller which is connected to the bus. Depending on the host controller interface used, it may have a single (as in case of AHCI used with the SATAe) or multiple (as in case of the NVMe) storage unit(s) associated with the controller. RAID volumes created including storage units which are associated with different controllers connected to different PCIe slots cannot be achieved with the above mentioned approach, as the hardware RAID controller and/or the emulated RAID card may not be able to access and/or control physical disks that arc not connected to the ports of the hardware RAID controller and/or the emulated RAID card.

Another conventional method (e.g. Intel Rapid Storage Technology, iRST) enables creating and deleting a RAID across devices connected on different PCIe slots. However, this conventional method is implemented as part of a base firmware of the associated motherboard, and thus this solution is tied with a main board.

### SUMMARY

An object of the embodiments of the inventive concepts herein is to provide methods to access a RAID volume in a pre-boot environment without dependency on a motherboard.

Another object of the embodiments of the inventive concepts herein is to provide methods for detecting, by a host device, at least two data storage devices by a single BIOS Expansion ROM image.

Another object of the embodiments of the inventive concepts herein is to provide methods for creating, by the host device, a boot connection vector with the at least two data storage devices.

Yet another object of the embodiments of the inventive concepts herein is to provide methods for using a completion queue for admin completion operations and IO complete operations.

Yet another object of the embodiments of the inventive concepts herein is to provide methods for using a submission queue for admin submission operation and IO submission operations.

Accordingly, the embodiments herein provide a data storage device including a host interface, at least two storage units coupled to the host interface. Further, the data storage device includes an Option ROM including a system code configured prior to boot to implement RAID to enable booting to a RAID volume independent of a motherboard.

Accordingly, the embodiments herein provide a data storage system including a host system including a host controller interface. Further, the data storage system includes a plurality of data storage devices connected to the host controller interface of the host system, where each of the plurality of data storage devices includes at least one storage unit and an Option ROM including a system code configured to implement RAID to enable booting to a RAID volume formed from the respective at least one storage unit of the plurality of data storage devices. The host system is configured to execute the system code from the Option ROM to enable the host system to communicate with the plurality of data storage devices to perform IO operations to boot an operating system from the RAID volume.

Accordingly, the embodiments herein provide a host system to access a RAID volume in a pre-boot environment. The host system includes, a processor, and a system code loaded from an Option ROM accessible by the processor. The system code is configured to detect at least one data storage device, including at least two storage units connected to a host controller interface. Further, the Option ROM is configured to create a boot connection vector with the at least two storage units.

Accordingly, the embodiments herein provide a host system to access a RAID volume in a pre-boot environment. The host system includes a processor, a host controller interface connected to the processor, and a memory region, connected to the processor, including a completion queue and a submission queue. The completion queue is configured to be used for administration completion operations and Input/Output (IO) completion operations, and the submission queue is configured to be used for administration submission operations and IO submission operations.

Accordingly, the embodiments herein provide a method to access a RAID volume in a pre-boot environment. The method includes executing, by a host system, a system code from an Option ROM of at least one storage device enabling a pre boot host program to communicate with at least two storage units to perform Input/Output (IO) operations to boot an operating system.

Accordingly, the embodiments herein provide a method to access a RAID volume in a pre-boot environment. The method includes detecting, by a host system, at least one data storage device, comprising at least two storage units, connected to a host controller interface. Further, the method includes creating, by the host system, a boot connection vector with the at least two storage units. The host system includes a processor and a memory connected to the processor, where the memory includes a system code loaded from an Option Read-Only Memory (ROM) of the at least one data storage device.

Accordingly, the embodiments herein provide a computer system including a processor, a memory coupled to the processor, a host controller interface coupled to the processor, and a plurality of storage devices coupled to the host controller interface, the plurality of storage devices including respective Option ROMs. The processor is configured to execute a system code loaded from one of the plurality of Option ROMs to cause the processor perform operations including forming a RAID volume from at least two of the plurality of storage devices.

Accordingly, the embodiments herein provide a first data storage device including a host interface, a first storage unit coupled to the host interface, and an Option ROM including a system code. The system code is configured, when executed on a processor, to perform operations including forming a RAID volume including the first storage unit and a second storage unit of a second data storage device, different from the first data storage device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

The inventive concepts are illustrated in the accompanying drawings, throughout which like reference numbers indicate the same or similar parts in the various figures. The embodiments herein will be better understood from the following description with reference to the drawings, in which:

FIG. 1a illustrates a conventional method in which RAID functionality is implemented inside a main board firmware;

FIG. 1b illustrates another conventional method in which RAID functionality is implemented in a host bus adapter;

FIG. 2 illustrates a system in which RAID functionality is implemented in an Option ROM of a data storage device, according to embodiments of the inventive concepts;

FIG. 3 illustrates a block diagram of a data storage device, according to embodiments of the inventive concepts;

FIGS. 4a and 4b show multiple devices, where each device's Option ROM instance is copied in a host memory and managed in a device-independent manner;

FIG. 4c illustrates a method of sharing an Expansion ROM Area, according to embodiments of the inventive concepts;

FIGS. 5a and 5b illustrate a conventional method of sharing an Extended Basic Input/Output System (BIOS) Data Area (EBDA);

FIG. 5c illustrates a method of sharing an EBDA, according to embodiments of the inventive concepts;

FIG. 6 illustrates a data storage system to access a RAID volume in a pre-boot environment, according to embodiments of the inventive concepts;

FIG. 7 illustrates a conventional implementation of Device Queues;

FIG. 8 illustrates a method of Device Queue Sharing, according to embodiments of the inventive concepts;

FIG. 9 illustrates a block diagram of a host system, according to embodiments of the inventive concepts:

FIG. 10 is a flowchart illustrating a method to access a RAID volume in a pre-boot environment, according to embodiments of the inventive concepts;

FIG. 11 is another flowchart illustrating a method for registering RAID IO interfaces in a legacy BIOS environment, according to embodiments of the inventive concepts;

FIG. 12 is a flowchart illustrating a method to enable booting to RAID volumes in a pre-boot environment, according to embodiments of the inventive concepts; and

FIG. 13 illustrates a computing environment implementing the method and system to access a RAID volume in a pre-boot environment, according to embodiments of the inventive concepts.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein disclose methods to access a RAID volume in a pre-boot environment. In some embodiments, methods to access the RAID volume may be independent of firmware loaded on the motherboard. The methods include executing, by a host system, a system code from an Option ROM of at least one data storage device enabling a pre boot host program to communicate with at least two storage units to perform IO operations to boot an operating system.

Another embodiment herein discloses methods to access a RAID volume in a pre-boot environment. The methods include detecting, by a host system, at least one data storage device, including at least two storage units, connected to a PCIe slot. Further, the methods may include creating, by the host system, a boot connection vector with the at least two storage units. The host system may include a processor and an Option ROM, connected to the processor. In an embodiment, in case of the normal boot mode, a legacy boot connection vector (BCV) may be created with one storage unit. However, in case of the RAID mode, one BCV may be created for one RAID volume.

In conventional systems and methods, there may be no RAID solution in the pre-boot environment which does not have dependency with the motherboard or hardware. As used herein, a pre-boot environment is a system environment prior to the booting and execution of an operating system controlling the system. Also, conventional systems may not provide an implementation of a RAID solution in a device Option ROM. Unlike conventional systems and methods, the RAID solution of the inventive concepts may be implemented in an Option ROM of the PCIe storage device which eliminates the dependency with the motherboard.

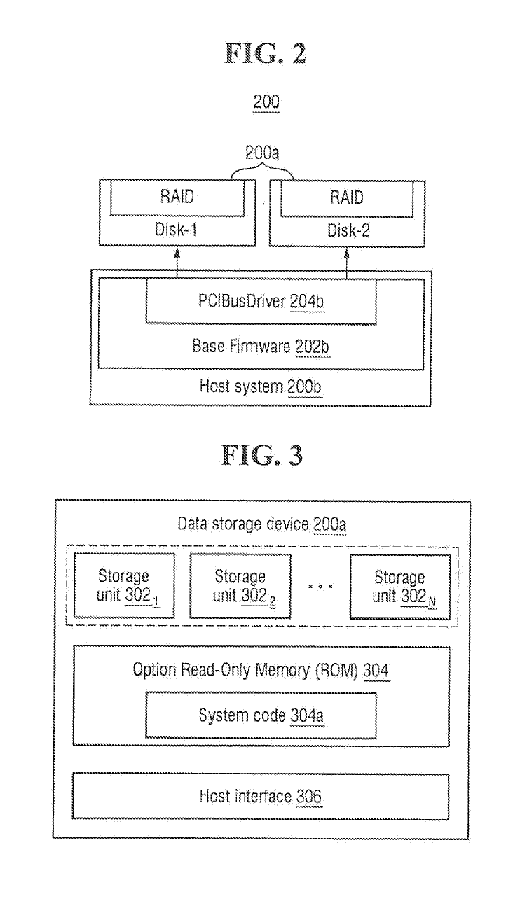

Referring now to the drawings, and more particularly to FIGS. 2, 3, 4c, 5c, 6, 8, through 13, where similar reference characters denote the same or similar features consistently throughout the figures, there are shown embodiments of the inventive concepts.

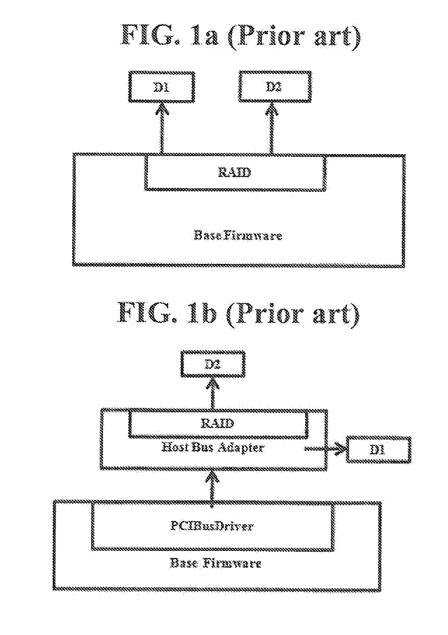

FIG. 1a illustrates a conventional method in which RAID functionality is implemented inside a main board firmware. As shown in FIG. 1a, the RAID functionality is implemented inside the main board firmware (i.e., motherboard firmware). Here, the conventional method enables creating and deleting a RAID configuration across multiple storage devices (e.g. D1 and/or D2) connected on different PCIe slots. However, the conventional method may be implemented as part of a base firmware code of the motherboard, which makes the conventional method motherboard dependent.

As shown in FIG. 1a, a RAID driver may be incorporated in the main board firmware. Further, as the RAID functionality may be integrated in the main board framework, vendors of the storage devices may be unable to customize the same. Further, this type of conventional method is only available when supported by the main board.

FIG. 1b illustrates another conventional method in which the RAID functionality is implemented in a host bus adapter. As shown in FIG. 1b, the RAID functionality is implemented in the adapter card (i.e., the host bus adapter). In this case, the RAID is created with the devices connected to the port of the adapter card. Further, the conventional method is not suitable for PCIe based SSDs (i.e. SSDs which do not use art adapter card).

FIG. 2 illustrates a system 200 in which the RAID functionality is implemented in an Option ROM of a data storage device 200a, according to embodiments of the inventive concepts. As used herein, the term Option ROM may be used and interpreted interchangeably with an Expansion ROM. In an embodiment, the system 200 includes one or more data storage devices 200a and a host system 200b. In art embodiment, the data storage device 200a may include, for example, a PCIe based flash SSDs. In an embodiment, the host system 200b may include a base firmware 202b and a PCI bus driver 204b. The PCI bus driver 204b may be in connection with the data storage devices 200a, such as a Disk-1 and a Disk-2. As shown in FIG. 2, the RAID functionality may be implemented in the Option ROM of the one or more data storage device 200a which enables booting to a RAID volume independent of the motherboard. Further, the proposed method is compatible across systems supporting a UEFI and a legacy BIOS interface. The functionalities of the data storage device 200a are explained in conjunction with FIG. 3.

Unlike conventional systems and methods, the systems and methods of the inventive concepts may enable booting to the RAID volume in the pre-boot environment applicable for Plug and Play (PnP) expansion devices (i.e., residing in the data storage device 200a). Further, in the systems and methods of the inventive concepts, a driver code may interact with the one or more data storage devices 200a and the RAID driver residing in the data storage devices 200a. Further, the systems and methods of the inventive concept may not depend on hardware or software component in the main board or the HBA.

FIG. 3 is a block diagram of the data storage device 200a, according to embodiments of the inventive concepts. In an embodiment, the data storage device 200a may include one or more storage units 302₁-302_{N} (i.e., hereafter referred as the storage units 302) coupled to a host interface 306, and an Option ROM 304. The Option ROM 304 may include a system code 304a. The host Interface 306 may communicate with a host over an interconnect with the host. For example, the host interface may include a PCI and/or PCIe interface, though the present inventive concepts are not limited thereto.

The Option ROM 304 including the system code 304a may be configured prior to booting an operating system to implement the RAID to enable booting to the RAID volume independent of the motherboard. Here, the data storage device 200a and the storage units 302 are independently bootable to an operating system installed in the one or more data storage devices 200a. In an embodiment, the Option ROM 304 and operating system driver may include a same RAID metadata format in the pre-boot environment and a run-time environment. In an embodiment, the pre-boot environment may be the legacy BIOS or the UEFI.

FIG. 3 shows limited components of the data storage device 200a but it is to be understood that other embodiments are not limited thereon. In some embodiments, the data storage device 200a may include less or more components than those illustrated in FIG. 3. Further, the labels or names of the components are used only for illustrative purpose and do not limit the scope of the inventive concepts. One or more components can be combined together to perform the same or substantially similar function in the data storage device 200a.

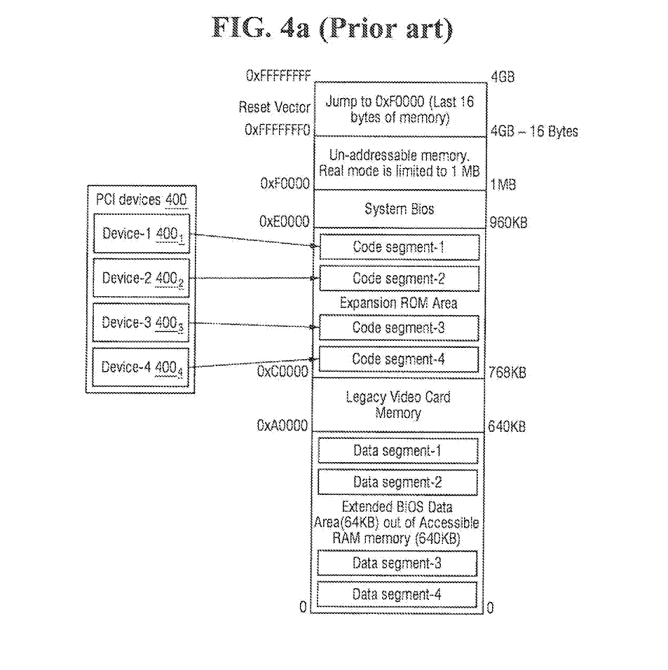

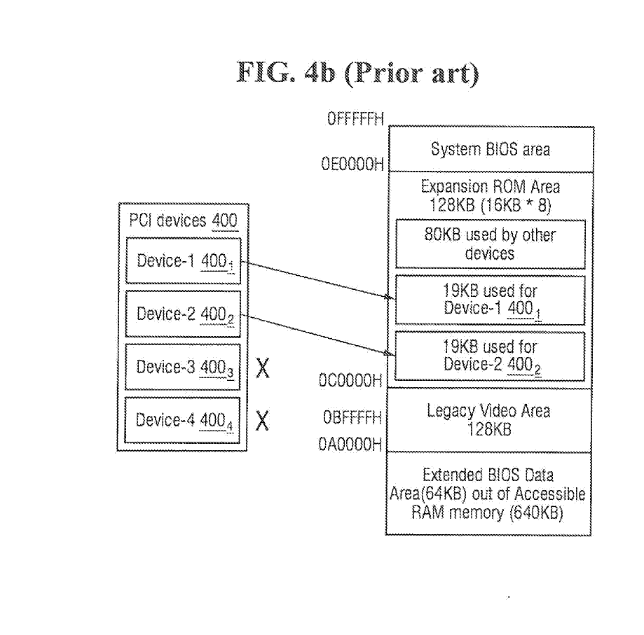

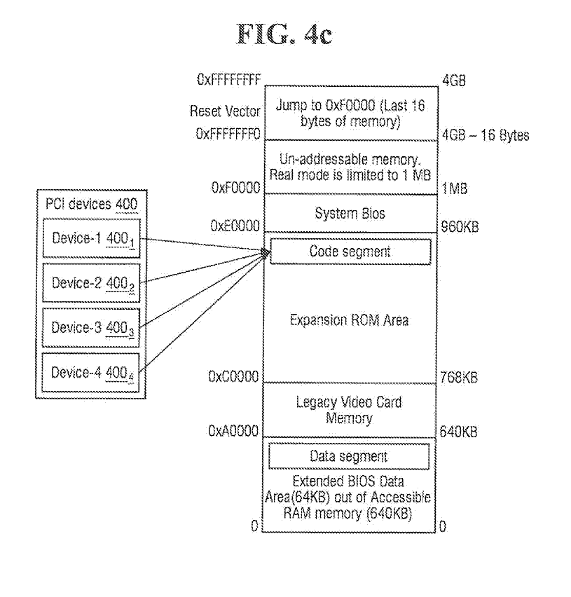

FIGS. 4a and 4b show multiple devices, where each device's Option ROM instance is copied in a host memory and managed in a device-independent manner. Consider a scenario where the Expansion ROM Area is 128 KB in size. The Expansion ROM Area is a memory region to which a BIOS copies the Option ROM image and executes it. Typically, the Expansion ROM area size is 128 KB and lies in the region 0C0000h to 0DFFFFh. Further in this scenario of the Expansion ROM Area, if 80 KB is occupied by other devices then, 46 KB of space will remain.

As shown in FIGS. 4a and 4b, consider a scenario where four PCI storage devices 400 (Device-1 400₁, Device-2 400₂, Device-3 400₃, and Device-4 400₄), each having a separate Option ROM having a size of 19 KB. If two of the PCI storage devices (i.e., Device-1 400₁ and Device-2 400₂) occupy 19*2=38 KB of code area, then the third and fourth PCI device (i.e., Device-3 400₃ and Device-4 400₄) do not have space within the Expansion ROM Area to execute.

FIG. 4c illustrates a method of sharing the Expansion ROM Area, according to embodiments of the inventive concepts. Consider a scenario where the Expansion ROM Area is 128 KB in size. All storage device option ROM images may be loaded and executed for all the storage devices. The proposed legacy Option ROM size is 19 KB. In the method according to the inventive concepts, the first Option ROM may enumerate all of the storage devices. For example, the first Option ROM may enumerate all the Non-Volatile Memory Express (NVMe) solid-state drives (SSDs). In some embodiments, first Option ROM may manage all or some of the storage devices rather than separately loading an Option ROM for each of the storage devices.

In some embodiments, one or more of the following techniques may be implemented in the Option ROM:

Initialization:
a. The Option ROM image may be copied from the data storage device 200a (see FIG. 2) and placed in the Expansion ROM area in 2 KB alignment.
b. The Option ROM may search in an address range C0000 to DFFFF, every 2 KB, and check if the Option ROM has already been loaded by a previous data storage device 200a. The starting Option ROM image may have a ROM header which has a vendor identifier (ID) and a device ID to aid in identification.
c. If the Option ROM has already been loaded for another data storage device 200a, the Option ROM execution may return without performing anything.
d. If the current Option ROM is the first Option ROM to be loaded then the method may perform the following as described below:
   i. Issue a PCI interrupt and detect all PCIe based storage interfaces in the system. For each device detected, initialize a controller and make the data storage device 200a ready for use. Also, store their bus device function and memory-based address register (MBAR) for the data storage device 200a in the controller information table. Like the bus device function, the MBAR is also unique for each data storage device 200a. This is the base address in the physical address space which the BIOS allocates to the data storage device 200a for memory-mapped input/output (MMIO) operations. The bus device function identifies a PCI device in the system. Different devices connected to different slots can have a different bus device function. It may be used to identify an individual data storage device 200a.
   ii. For each namespace in the controller, the Option ROM may create a PnP header for the BIOS to detect the namespace as a bootable device. Create the PnP header for each namespace so that it is identified as a separate boot drive.

Interrupt registration:
a. For each namespace define boot connection vectors which hook a same Interrupt 13 (Int13) handler and also add a record in a DriveInfo table. The DriveInfo table may map the drive number sent by Int13 to the appropriate namespace it is associated to. This is applicable in the legacy mode of booting the system.

Interrupt handling:
a. Since each Int13 request sends the drive number, map the drive number in the DriveInfo table, and locate which controller and which namespace the drive belongs to and route the command accordingly.

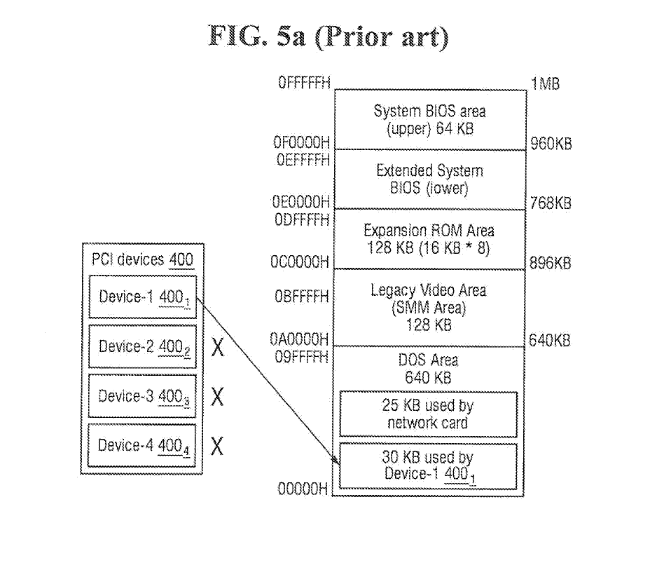

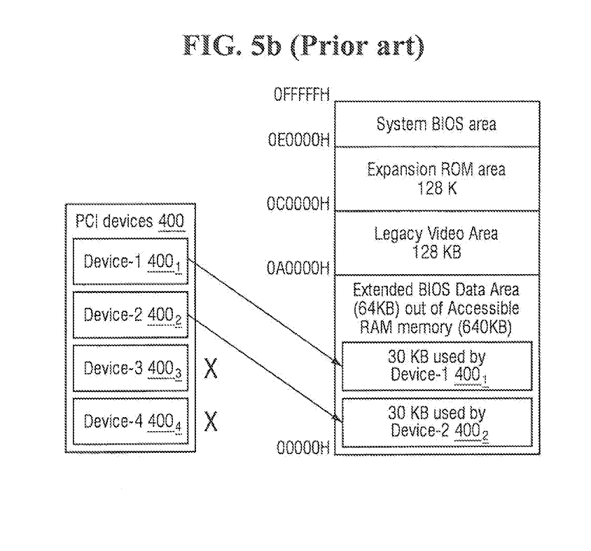

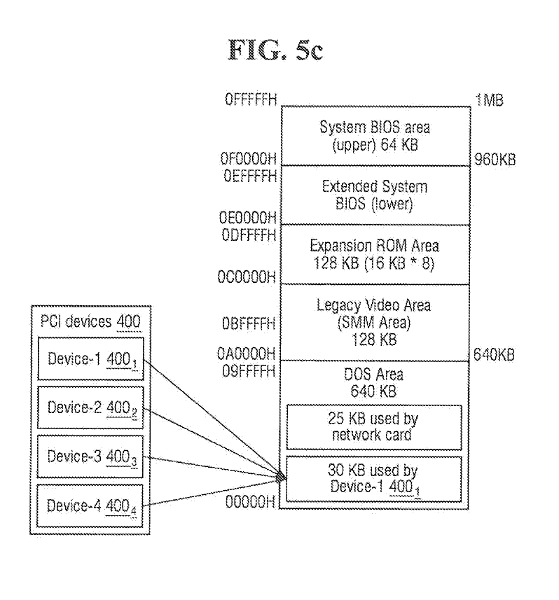

FIGS. 5a and 5b illustrate conventional methods of sharing the EBDA. Consider a scenario where the EBDA space is 64 KB in size. In EBDA memory, if 30 KB is required for each device, then not more than 2 devices (e.g. Device-1 400₁ and Device-2 400₂) can be connected as shown in FIG. 5b.

As shown in FIG. 5b, the memory for the device queues is allocated in the EBDA memory region, which is 64 KB in size and is used for all the devices. The NVMe Option ROM uses around 30 KB of EBDA region, thus allowing only 2 devices to be detected.

FIG. 5c illustrates a method of sharing the EBDA, according to embodiments of the inventive concepts. To overcome the above disadvantage, a technique is proposed which re-uses the first NVMe SSDs EBDA memory (e.g. the EBDA associated with Device-1 400₁) for all NVMe SSDs, thus supporting many devices. In some embodiments, the use of a single option ROM to manage multiple storage devices (e.g. PCI devices 400₁, 400₂, 400₃, and 400₄) may allow for the use of a single area of EBDA memory to manage the multiple storage devices, thus reducing the amount of EBDA memory required.

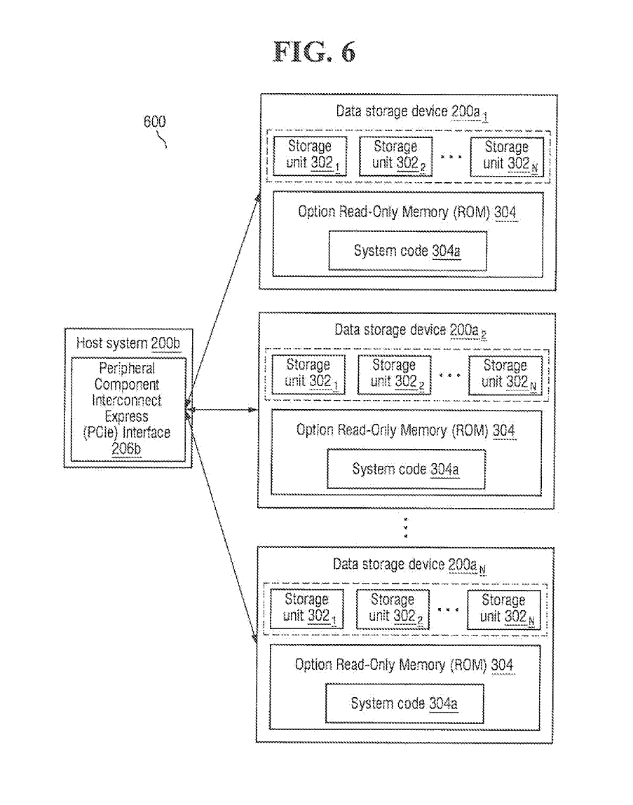

FIG. 6 illustrates a data storage system 600 to access the RAID volume in the pre-boot environment, according to embodiments of the inventive concepts. In an embodiment, the data storage system 600 may include the host system 200b and a plurality of data storage devices 200a₁-200a_{N}. The host system 200b may include a PCIe interface 206b. Here, the plurality of data storage devices 200a₁-200a_{N} (hereafter referred as the data storage device(s) 200a) may be connected to the PCIe interface 206b. The data storage device 200a may include the storage units 302 and the Option ROM 304. The Option ROM 304 may include the system code 304a.

The Option ROM 304 including the system code 304a can be configured prior to boot to implement the RAID to enable booting to the RAID volume independent of the motherboard. The host system 200b can be configured to execute the system code 304a from the Option ROM 304 of the data storage device 200a enabling a host program to communicate with the storage units 302 to perform IO operations to boot the operating system.

Further, the host system 200b in communication with the Option ROM 304 in the data storage device 200a may be configured to scan the PCIe interface 204b to detect the additional data storage devices 200a. Further, the host system 200b in communication with the Option ROM 304 in the data storage device 200a may be configured to initialize the detected data storage devices 200a to read RAID metadata, where the RAID metadata includes information about the RAID volume, include a Globally Unique Identifier (GLIB), a total size of the RAID volume, and/or a RAID level. Further, the host system 200b in communication with the Option ROM 304 in the data storage devices 200b may be configured to install a RAID IO interface on a detected RAID volume to report the RAID volume as a single IO unit.

Further, the host system 200b can be configured to install a normal IO interface on non-RAID volumes. That is to say that some of the data storage devices 200a accessed by the host system 200b may configured in a RAID volume and others of the data storage devices 200a may be configured in another RAID volume, or in a non-RAID configuration. In an embodiment, the data storage device 200a and the storage units 302 may be independently bootable to the operating system installed in the data storage device 200a. In an embodiment, the Option ROM 304 and OS driver may parse a same RAID metadata format in the pre boot environment and a run-time environment. The pre-boot environment may be one of the Legacy BIOS interface or the UEFI.

FIG. 6 shows limited components of the data storage system 600 but it is to be understood that other embodiments are not limited thereon. In other embodiments, the data storage system 600 may include less or more components than those illustrated in FIG. 6. Further, the labels or names of the components are used only for illustrative purpose and do not limit the scope of the invention. One or more components can be combined together to perform the same or substantially similar function in the data storage system 600.

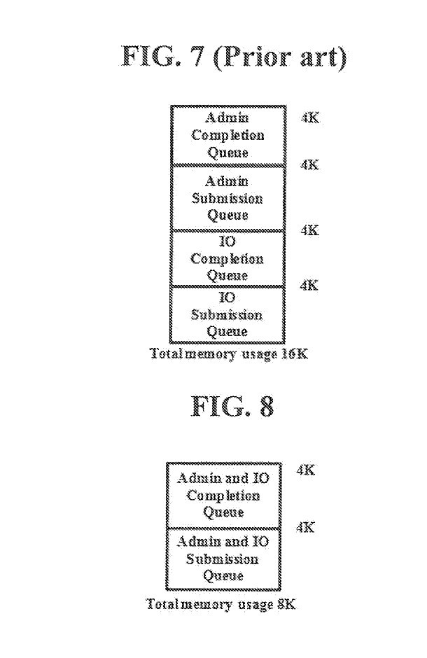

FIG. 7 illustrates a conventional implementation of Device Queues, including a conventional memory layout for the device queues. As illustrated in FIG. 7, the device queues may include separate admin completion and submission queues, and separate IO completion and submission queues.

FIG. 8 illustrates a method of Device Queue Sharing according to embodiments of the inventive concepts. Generally, EBDA is the region which is used by the legacy Option ROM as a data segment, and this area is may be used by the device. The device may pick up commands and post responses in queues allocated in the EBDA.

Some host controller interfaces specify a different set of request and response queues for IO and management purposes. As used herein, request/response queues used for IO may be queues that contain data and/or commands related to IO operations being performed. As used herein, request/response queues used for management and/or administration may be queues that contain data and/or commands related to managing the device, in a single threaded execution environment, communication between the host and the device can be in a synchronous manner. As illustrated in FIG. 8, the separate administration and IO Submission queues (see FIG. 7) may be combined into a single Admin and IO Submission queue, and the separate administration and IO Completion queues (see FIG. 7) may be combined into an a single Admin and IO Completion queue. As used herein, a Submission queue may be a queue for storing/submitting requests, and a Completion queue may be a queue for storing/receiving responses to submitted requests. Further, the host memory region can be registered as the queues for management and IO purposes.

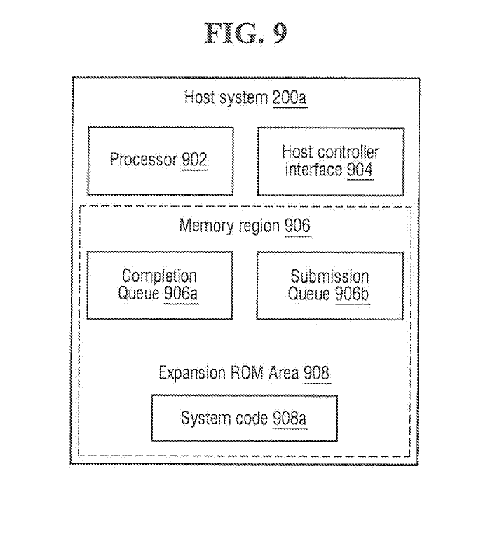

FIG. 9 is a block diagram of the host system 200b, according to embodiments of the inventive concepts. In an embodiment, the host system 200b may include a processor 902, a host controller interface 904 connected to the processor 902, and a memory region 906, connected to the processor 902. The memory region 906 may include a completion queue 906a, a submission queue 906b, and an Expansion ROM Area 908. The completion queue 906a may be used for an admin complete operation and/or an IO complete operation. Further, the submission queue 906b may be used by an admin submission operation and/or an IO submission operation. The Expansion RUM Area 908 may include a system code 908a. In some embodiments, the system code 908a may be a portion of the system code 9087a loaded from an Option ROM of a device (see FIGS. 3 and 4C) connected to the host system 200b via the host controller interface 904.

In an embodiment, the submission queue 906b may be accessed when a request is posted by the system code 908a to an admin submission queue and a response is posted to an admin completion queue. In an embodiment, the completion queue 906a is accessed when a request is posted to the admin submission queue and a response is posted by the host system 200b to the admin completion queue.

FIG. 9 shows limited components of the host system 200b but it is to be understood that other embodiments are not limited thereon. In other embodiments, the host system 200b may include less or more components than those illustrated in FIG. 9. Further, the labels or names of the components are used only for illustrative purpose and do not limit the scope of the inventive concepts. One or more components can be combined together to perform the same or substantially similar function in the host system 200b.

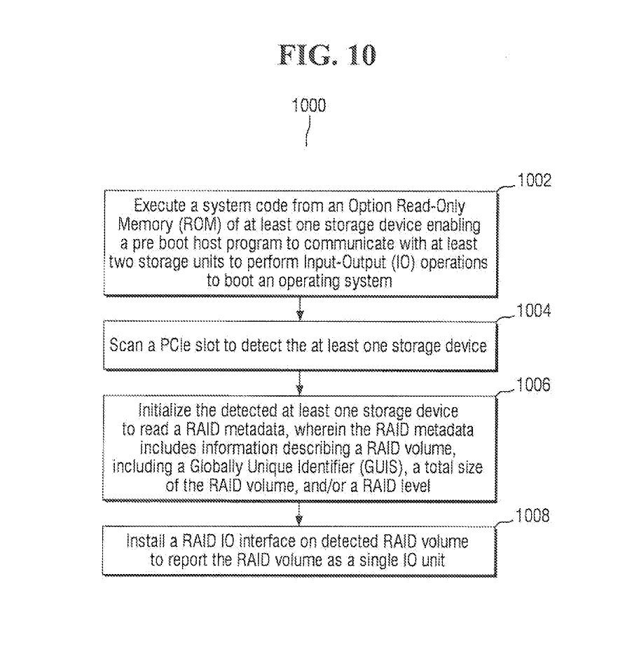

FIG. 10 is a flowchart illustrating a method 1000 to access the RAID volume in the pre-boot environment, according to embodiments of the inventive concepts. Referring to FIGS. 3 and 10, At operation 1002, the method includes executing the system code 304a from the Option ROM 304 of the data storage device 200a enabling the pre-boot host program to communicate with the storage units 302 to perform IO operations to boot the operating system. The method may allow the host system 200b to execute the system code 304a from the Option ROM 304 of the data storage device 200a enabling the pre-boot host program to communicate with the storage units 302 to perform IO operations to boot the operating system.

At operation 1004, the method may include scanning the PCIe interface 206b to detect the data storage device 200a. The method may allow the host system 200b to scan the PCIe interface 206b to detect the data storage device 200a. At operation 1006, the method includes initializing the detected data storage device 200a to read the RAID metadata, where the RAID metadata may include information related to the RAID volume including the GUID, the total size of the RAID volume, and/or the RAID level.

At operation 1008, the method may include installing the RAID IO interface for the detected RAID volume to report the RAID volume as a single IO unit. In an embodiment, the host system 200b may install the normal IO interface for the non-RAID volumes. In an embodiment, the Option ROM 304 may include the system code 304a configured to implement RAID and/or to enable booting to the RAID volume independent of the motherboard. In an embodiment, the pre-boot environment may be one of the Legacy BIOS interface and the UEFI.

The various actions, acts, blocks, operations, or the like in the flow chart 1000 may be performed in the order presented, in a different order or simultaneously. Further, in some embodiments, some of the actions, blocks, operations, or the like may be omitted, added, modified, skipped, or the like without departing from the scope of the inventive concepts.

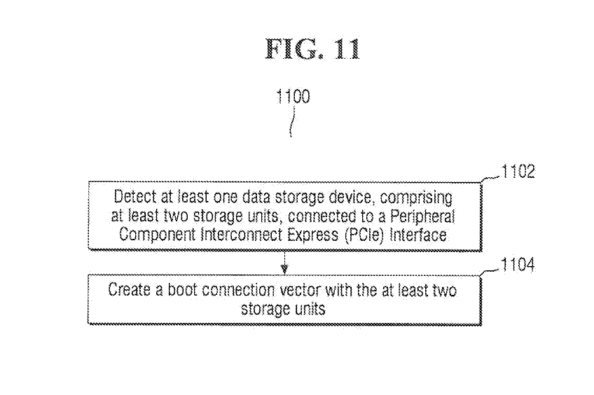

FIG. 11 is another flowchart 1100 illustrating a method for registering the RAID IO interfaces in a legacy BIOS environment, according to embodiments of the inventive concepts.

At operation 1102, the method may include detecting the data storage device 200a, comprising the storage units 302, connected to the PCIe slot 206b. At operation 1104, the method may include creating the boot connection vector with the storage units 302.

In an embodiment, the data storage device 200a comprising the storage units 302 may include the system code 304a configured to implement RAID to enable booting to RAID volume in the Option ROM 304.

The various actions, acts, blocks, operations, or the like in the flow chart 1100 may be performed in the order presented, in a different order or simultaneously. Further, in some embodiments, some of the actions, blocks, operations, or the like may be omitted, added, modified, skipped, or the like without departing from the scope of the invention.

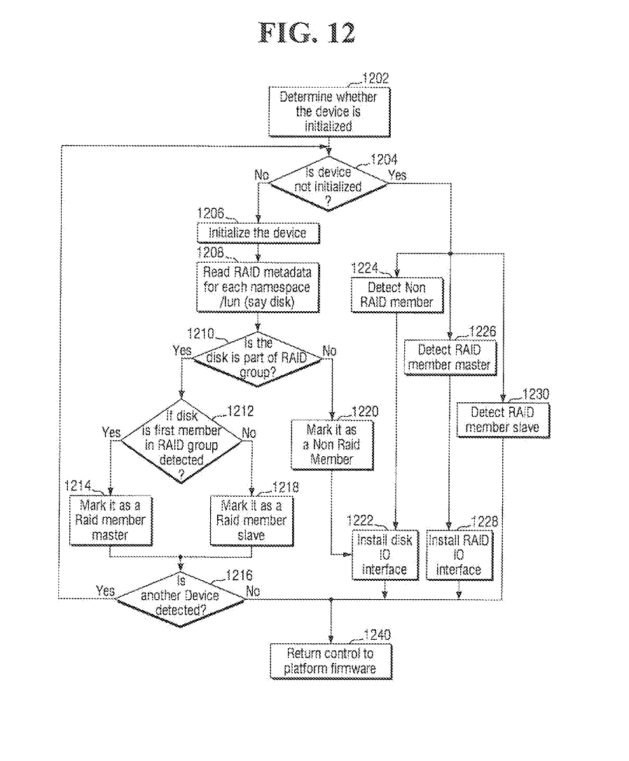

FIG. 12 is a flowchart 1200 illustrating a method to enable booting to a RAID volume in the pre-boot environment, according to embodiments of the inventive concepts. For each storage device connected, the below described process may be followed. At operation 1202, the method may include determining whether the device is initialized.

At operation 1204, if it is determined that the device is not initialized then, at operation 1206, the method may include initializing the storage device. At operation 1208, the method may include reading the RAID metadata for each namespace and/or logical unit number (LUN) (e.g. disk). At operation 1210, if it is determined that the disk is part of the RAID group then, at operation 1212, the method may include determining whether the disk is a first member in the RAID group.

At operation 1212, if it is determined that the disk is the first member in the RAID group then, at operation 1214, the method may include marking the disk as a RAID member master. At operation 1216, if it is determined that another device is detected then, the method may proceed to operation 1204. At operation 1216, if it is determined that another device is not detected then, the method may include operation 1240 returning control to platform firmware.

At operation 1212, if it is determined that the disk is not the first member in the RAID group then, at operation 1218, the method may include marking the disk as a RAID member slave and method is looped to operation 1216. At operation 1210, if it is determined that the disk is not part of the RAID group then, at operation 1220, the method may include marking the disk as a non RAID member. At operation 1222, the method may include installing a disk IO interface (e.g. non-RAID), and the method may proceed to operation 1240.

At operation 1204, if it is determined that the device is initialized then, at operation 1224, the method may include determining whether the disk is non RAID member. At operation 1224, if it is determined that the disk is the non RAID member then, the method may proceed to operation 1222. At operation 1204, if it is determined that the device is initialized then, at operation 1226, the method may include determining whether the disk is the RAID member master. At operation 1226, if it is determined that the disk is the RAID member master then, at operation 1228, the method includes installing RAID IO interface and the method proceeds to operation 1240.

At operation 1204, if it is determined that the device is initialized then, at operation 1230, the method may include determining whether the disk is the RAID member slave. At operation 1230, if it is determined that the disk is the RAID member slave then, the method may proceed to operation 1240.

The various actions, acts, blocks, operations, or the like in the flow chart 1200 may be performed in the order presented, in a different order or simultaneously. Further, in some embodiments, some of the actions, blocks, operations, or the like may be omitted, added, modified, skipped, or the like without departing from the scope of the inventive concepts.

In an embodiment, consider storage devices C1 to C6 and storage units D1 to D9 as shown in the below table-1:

TABLE 1

| Devices | Storage Unit |
|---|---|
| C1 | D1 |
| C2 | D2, D3, D4 |
| C3 | D5 |
| C4 | D6 |
| C5 | D7, D8 |
| C6 | D9 |

Initially, for each storage device Cx, perform the following as described below:
a. (Operation-1) Query the DEVICE_INFO_TABLE with the BusDeviceFunction. The DEVICE_INFO_TABLE stores bookkeeping information about the storage device. The information such as the PCI bus device function, number of namespace addresses of the queues in a host memory, etc.
b. If Entry doesn't exist
   i. Initialize storage device.
   ii. Create DISK_INFO_TABLE for the storage device. The DISK_INFO_TABLE stores bookkeeping information about the storage units 302 associated with the storage device 200a (see FIG. 3). The marking whether the storage unit 302 is the RAID master, Slave, or non-RAID may be set in the DISK_INFO_TABLE.
   iii. For each storage unit Dx in the storage device Cx, do the following:
      1. Read disk data format (Ddf) for the storage unit
         If storage unit is part of RaidGroup
         If the storage unit is first member in RaidGroup detected (query RAID_INFO_TABLE). The RAID_INFO_TABLE stores bookkeeping information about the RAID groups. When the first member of the RAID group is found, it creates an entry in the table. Subsequently other RAID member storage units update the entry.
         Mark the storage unit as a RaidMemberMaster Add new entry in RAID_INFO_TABLE
         Else
         Mark the storage unit as RaidMemberSlave Update RAID_INFO_TABLE
         Else
         Mark the storage unit as NonRaidMember
      2. Add entry in DISK_INFO_TABLE
   iv. Add entry in DEVICE_INFO_TABLE
   v. If Dx is marked as RaidMemberMaster, and if is the first master in entire system
      1. Locate all the storage devices
      2. For each located storage device, do the following:
         a. Loop to Operation-1
   Else
      Copy the DeviceEntry and store it in context structure
      If Dx is marked as RaidMemberMaster, install RAID Block IO (Block IO is the interface as per UEFI spec.)
      If Dx is marked as RaidMemberSlave, do not install RAID Block IO
      If Dx is marked as NonRaidMember, install Block IO. In this case, normal mode IO interface is registered.

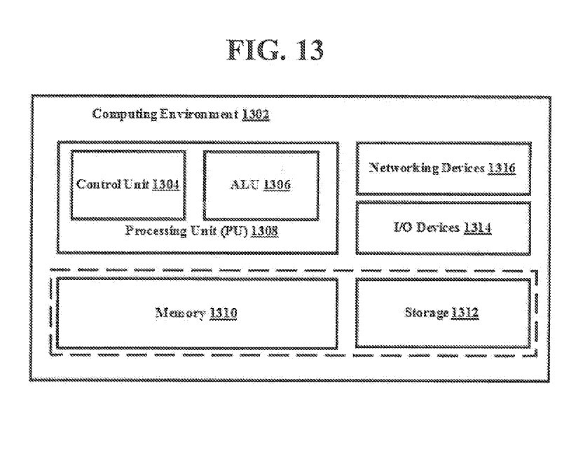

FIG. 13 illustrates a computing environment 1302 implementing the method and system to enable booting to a RAID volume in a pre-boot environment, according to embodiments of the inventive concepts. As depicted in the figure, the computing environment 1302 may include at least one processing unit 1308 that is equipped with a control unit 1304 and an Arithmetic Logic Unit (ALU) 1306, a memory 1310, a storage unit 1312, plurality of networking devices 1316, and a plurality Input output (I/O) devices 1314. The processing unit 1308 may be responsible for processing the instructions that implement operations of the method. The processing unit 1308 may receive commands from the control unit 1304 in order to perform its processing. Further, any logical and arithmetic operations involved in the execution of the instructions may be computed with the help of the ALU 1306.

The overall computing environment 1302 can be composed of multiple homogeneous or heterogeneous cores, multiple CPUs of different kinds, special media and other accelerators. Further, the plurality of processing units 1308 may be located on a single chip or over multiple chips.

The instructions and codes used for the implementation of the methods described herein may be stored in either the memory unit 1310 and/or the storage 1312. At the time of execution, the instructions may be fetched from the corresponding memory 1310 and/or storage unit 1312, and executed by the processing unit 1308.

Various networking devices 1316 or external I/O devices 1314 may be connected to the computing environment 1302.

The embodiments disclosed herein can be implemented through at least one software program running on at least one hardware device and performing network management functions to control the elements. The elements shown in FIGS. 2, 3, 4c, 5c, 6, 8, through 13 include blocks which can be at least one of a hardware device, or a combination of hardware device and software units.

It will be understood that although the terms “first,” “second,” etc. are used herein to describe members, regions, layers, portions, sections, components, and/or elements in example embodiments of the inventive concepts, the members, regions, layers, portions, sections, components, and/or elements should not be limited by these terms. These terms are only used to distinguish one member, region, portion, section, component, or element from another member, region, portion, section, component, or element. Thus, a first member, region, portion, section, component, or element described below may also be referred to as a second member, region, portion, section, component, or element without departing from the scope of the inventive concepts. For example, a first element may also be referred to as a second element, and similarly, a second element may also be referred to as a first element, without departing from the scope of the inventive concepts.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” if used herein, specify the presence of stated features, integers, steps, operations, elements and/or components, but do not preclude the presence or addition of one or more other features, integers, steps, operations, elements, components and/or groups thereof. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terms (including technical and scientific terms) used herein have the same meaning as commonly understood by those of ordinary skill in the art to which the inventive concepts pertain. It will also be understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When a certain example embodiment may be implemented differently, a specific process order may be performed differently from the described order. For example, two consecutively described processes may be performed substantially at the same time or performed in an order opposite to the described order.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

The foregoing description of the specific embodiments will so fully reveal the general nature of the embodiments herein that others can, by applying current knowledge, readily modify or adapt for various applications such specific embodiments without departing from the inventive concepts, and, therefore, such adaptations and modifications should and are intended to be comprehended within the meaning and range of equivalents of the disclosed embodiments of the inventive concepts. It is to be understood that the phraseology or terminology employed herein is for the purpose of description and not of limitation. Therefore, while the embodiments herein have been described in terms of certain embodiments, those skilled in the art will recognize that the embodiments herein can be practiced with modification within the spirit and scope of the inventive concepts as described herein.

1.-5. (canceled)

6. A data storage system comprising:
a host system comprising a host controller interface; and
a plurality of data storage devices connected to the host controller interface of the host system, wherein each of the plurality of data storage devices comprises;
at least one storage unit; and
Option Read-Only Memory (ROM) comprising a system code configured to implement Redundant Array of Independent Disks (RAID) to enable booting to a RAID volume formed from the respective at least one storage unit of the plurality of data storage devices, wherein the host system is configured to execute the system code from the Option ROM to enable the host system to communicate with the plurality of data storage devices to perform Input/Output (IO) operations to boot an operating system from the RAID volume.

7. The data storage system of claim 6, wherein the host system is further configured to execute the system code from the Option ROM to:
scan the host controller interface to detect, the at least one storage device;
initialize the detected at least one storage device to read a RAID metadata, wherein the RAID metadata comprises information about the RAID volume comprising a Globally Unique Identifier (GUID), a total size of the RAID volume, and/or a RAID level; and
install a RAID IO interface on the RAID volume to report the RAID volume as a single IO unit.

8. The data storage system of claim 7, wherein the host system is further configured to install a non-RAID IO interface on non-RAID volumes.

9. The data storage system of claim 7, wherein the Option ROM comprises the system code configured to implement RAID to enable booting to the RAID volume independent of a motherboard of the host system.

10. The data storage system of claim 7, wherein ones of the plurality of data storage devices are independently bootable to the operating system stored in the ones of the plurality of data storage devices.

11. The data storage system of claim 7, wherein the Option ROM and an operating system driver parses a same RAID metadata format in a pre boot environment and a run-time environment.

12.-25. (canceled)

26. A computer system comprising:
a processor;
a memory coupled to the processor;
a host controller interface coupled to the processor; and
a plurality of storage devices coupled to the host controller interface, the plurality of storage devices comprising respective Option Read Only Memories (ROMs),
wherein the processor is configured to execute a system code loaded from one of the respective Option ROMs to cause the processor perform operations comprising forming a Redundant Array of Independent Disks (RAID) volume from at least two of the plurality of storage devices.

27. The computer system of claim 26, wherein the processor is further configured to boot an operating system from the RAID volume.

28. The computer system of claim 26, wherein the processor is configured to form the RAID volume from the at least two of the plurality of storage devices independently of a firmware of the computer system.

29. The computer system of claim 26, wherein the system code is loaded from a first Option ROM of the respective Option ROMs loaded from a first storage device of the plurality of the storage devices, and
wherein the processor is further configured to manage a second storage device of the plurality of storage devices using the first Option ROM.

30. The computer system of claim 29, wherein the processor is further configured to:
associate a first section of an Extended Basic Input/Output System (BIOS) Data Area (EBDA) for the first storage device of the plurality of the storage devices, and associate the first section of the EBDA with the second storage device of the plurality of storage devices.

31. The computer system of claim 30, wherein the system code loaded from the one of the respective Option ROMs causes the processor to perform operations further comprising forming a first device queue and a second device queue in the first section of the EBDA,
wherein the first device queue stores both administrative and Input/Output (IO) requests, and
wherein the second device queue stores both administrative and IO responses.

32. The computer system of claim 26, wherein the system code loaded from the one of the respective Option ROMs causes the processor to perform operations further comprising scanning the host controller interface to detect the plurality of storage devices.

33. The computer system of claim 32, wherein the system code loaded from the one of the respective Option ROMs causes the processor to perform operations further comprising reading RAID metadata from respective ones of the plurality of storage devices.

34. The computer system of claim 33, wherein the RAID metadata comprises information about the RAID volume, including a Globally Unique Identifier (GUID), a total size of the RAID volume, and/or a RAID level.

35. The computer system of claim 26, wherein the system code loaded from the one of the respective Option ROMs is a first system code loaded from a first Option ROM,
wherein the processor is configured to execute a second system code loaded from a second Option ROM of the respective Option ROMs,
wherein the second system code ceases execution responsive to a detection of the first system code loaded from the first Option ROM.

36. A first data storage device comprising:
a host interface;
a first storage unit coupled to the host interface; and
an Option Read-Only Memory (ROM) comprising a system code that when executed on a processor is configured to cause the processor to perform operations comprising:
forming a Redundant Array of Independent Disks (RAID) volume comprising the first storage unit and a second storage unit of a second data storage device, different from the first data storage device.

37. The first data storage device of claim 36, wherein the operations further comprise booting an operating system from the RAID volume.

38. The first data storage device of claim 36, wherein the operations further comprise reading RAID metadata from the first data storage device and the second data storage device.

39. The first data storage device of claim 38, wherein the RAID metadata comprises information about the RAID volume, including a Globally Unique Identifier (GUID), a total size of the RAID volume, and/or a RAID level.
